(19) United States
(12) Patent Application Publication
(10) Pub. No.: US 2007/0223028 A1
(43) Pub. Date: Sep. 27, 2007

(54) Adjustment of sleep timeouts in printers

(76) Inventors: J. Wesley Boyes JR., Loveland, CO (US); Jason James Grams, Broomfield, CO (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/388,501

(22) Filed: Mar. 23, 2006

(51) Int. Cl. G06K 15/00

(52) U.S. Cl. 358/1.14

(57) ABSTRACT

Provided are a method, system, and article of manufacture, wherein printer usage corresponding to a plurality of time periods of a day is determined for a plurality of days. Sleep timeout periods corresponding to the plurality of time periods of the day are set based on the determined printer usage.

### BACKGROUND

1. Field

The disclosure relates to a method, system, and article of manufacture for the adjustment of sleep timeouts in printers.

2. Background

Certain printers are implemented such that the printers can be set to a sleep mode. During sleep mode power may be conserved in a printer by turning off or reducing power to a fuser element of a printer. Power may also be reduced to the mimor motor, post processing devices, displays, or console, during sleep mode. A printer may enter the sleep mode, if the printer is idle for a predetermined period of time, where the predetermined period of time may be referred to as a fuser sleep timeout period or a sleep timeout period.

Many printers allow fuser sleep timeout periods to be configured by an operator. Certain implementations allow the operator to set the fuser sleep timeout period to a predetermined period of time. After printing the last page of a print job, the printer waits for the predetermined period of time for the next print job to arrive. If the predetermined time period passes without the arrival of the next print job at the printer, then the fuser element of the printer is powered down and the printer enters the sleep mode. When the next print job arrives, the printer wakes up from the sleep mode and starts printing.

### SUMMARY OF THE DESCRIBED EMBODIMENTS

Provided are a method, system, and article of manufacture, wherein printer usage corresponding to a plurality of time periods of a day is determined for a plurality of days. Sleep timeout periods corresponding to the plurality of time periods of the day are set based on the determined printer usage.

In additional embodiments, a first sleep timeout period is set for a first time period of the day, wherein a second sleep timeout period is set for a second time period of the day, and wherein the first sleep timeout period is more than the second sleep timeout period if the printer usage during the first time period of the day is more than the printer usage during the second time period of the day.

In further embodiments, a determination is made for a time period whether an average time interval between print jobs is less than a predetermined multiple of a printer wakeup time. In response to determining that the average time interval between the print jobs is less than the predetermined multiple of a printer wakeup time, a sleep timeout period corresponding to the time period is set to equal a maximum timeout period.

In yet further embodiments, the sleep timeout period corresponding to the time period is computed to be a predetermined multiple of the average time interval between print jobs, in response to determining that the average time interval between the print jobs is not less than the predetermined multiple of the printer wakeup time.

In still further embodiments, the sleep timeout period is set to equal the computed sleep timeout period if the computed sleep timeout period is greater than or equal to a minimum timeout period and the computed sleep timeout period is less than or equal to the maximum timeout period. Additionally, the sleep timeout period is set to equal the minimum timeout period, if the computed sleep timeout period is less than the minimum timeout period. Furthermore, the sleep timeout period is set to equal the maximum timeout period, if the computed sleep timeout period is greater than the maximum timeout period.

### BRIEF DESCRIPTION OF THE DRAWINGS

Referring now to the drawings in which like reference numbers represent corresponding parts throughout:

FIG. 1 illustrates a block diagram of a computing environment in accordance with certain embodiments;

FIG. 2 illustrates a block diagram that shows data structures and operations for determining timeout periods, in accordance with certain embodiments;

FIG. 3 illustrates a flowchart for modifying and adjusting timeout periods, in accordance with certain embodiments;

FIG. 4 illustrates a flowchart for setting timeout periods, in accordance with certain embodiments; and

FIG. 5 illustrates the architecture of computing system, wherein in certain embodiments the computational platform of the computing environment of FIG. 1 may be implemented in accordance with the architecture of the computing system.

### DETAILED DESCRIPTION

In the following description, reference is made to the accompanying drawings which form a part hereof and which illustrate several embodiments. It is understood that other embodiments may be utilized and structural and operational changes may be made.

Certain embodiments allow a user to set the fuser sleep timeout period for a printer to different values for various times of the day. Such embodiments allow energy savings during those times of the day when the printer is less active.

In certain embodiments, during periods of the day when significant printer activity is anticipated, the fuser sleep timeout period will be longer than during those times of the day when significant printer activity is not anticipated. Furthermore, in certain embodiments the printer can be set to automatically determine, by analyzing printer usage statistics, those time periods of the day when the printer is more active.

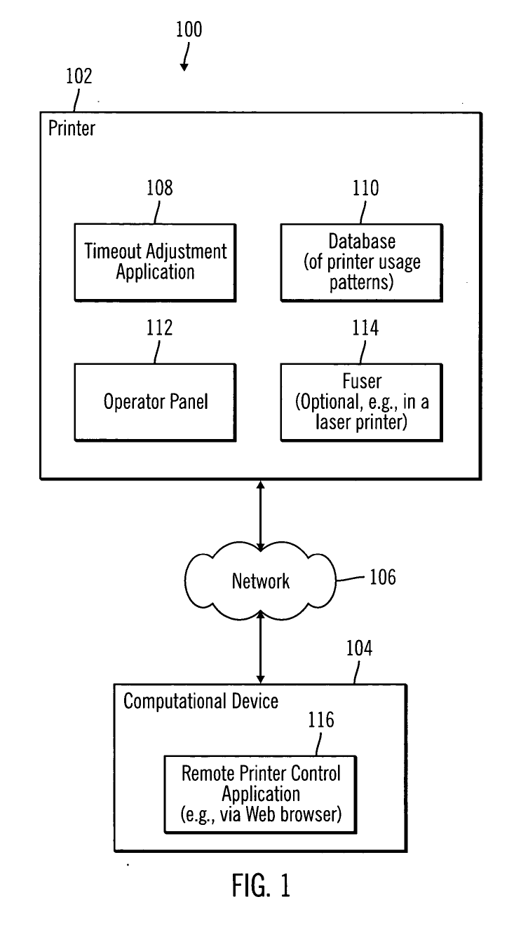

FIG. 1 illustrates a block diagram of a computing environment 100 in accordance with certain embodiments. One or more printers 102 are coupled to one or more computational devices 104 over a network 106. The printer 102 may comprise any type of printer, including those presently known in the art, such as, a laser printer, an inkjet printer, a plotter, etc. The computational device 104 may comprise any suitable computational platform, including those presently known in the art, such as, personal computers, workstations, mainframes, midrange computers, network appliances, palm top computers, telephony devices, blade computers, hand held computers, etc. The network 106 may comprise any network, including those presently known in the art, such as, the Internet, an intranet, a local area network, a wide area network, etc. In certain alternative embodiments, the computational device 104 may be directly coupled to the printer 102 without the network 106. In yet additional embodiments, certain or all of the functions performed by the computational device 104 may be implemented in the printer 102.

The printer 102 may include a timeout adjustment application 108, a database 110 that maintains statistics on printer usage patterns, an operator panel 112, and optionally a fuser 114 in embodiments in which the printer 102 is a laser printer.

The timeout adjustment application 108 may be implemented in hardware, firmware, software or any combination thereof in the printer 102. The timeout adjustment application 108 may store statistics on printer usage patterns in the database 110 and use the stored statistics on the printer usage patterns to set the sleep timeout period of the printer 102. In embodiments, in which the printer 102 is a laser printer the sleep timeout period is set for the fuser 114 by the timeout adjustment application 108.

The operator panel 112 may allow a user or administrator of the printer 102 to manually set various predetermined values of the sleep timeout period for the printer 102. In certain embodiments, the operator panel 112 may be also used to set various parameters for the timeout adjustment application 108.

In certain embodiments, the computational device 104 includes a remote printer control application 116 that may be used to control the printer 102. In certain embodiments, the remote printer control application 116 may be implemented such that the remote printer control application 116 is executed via a Web browser. In certain embodiments, the remote printer control application 116 may be used to set various predetermined values of the sleep timeout periods for the printer 102. In certain other embodiments, the remote printer control application 116 may also be used to set various parameters for the timeout adjustment application 108 to start executing.

Therefore, FIG. 1 illustrates certain embodiments in which sleep timeout periods for a printer 102 are set by a timeout adjustment application 108, such that the sleep timeout periods may be different at different times of the day. In certain alternative embodiments, the timeout adjustment application 108 and the database 110 may be implemented outside the printer. For example, in certain embodiments, the timeout adjustment application 108 and the database 110 may be implemented in the computational device 104.

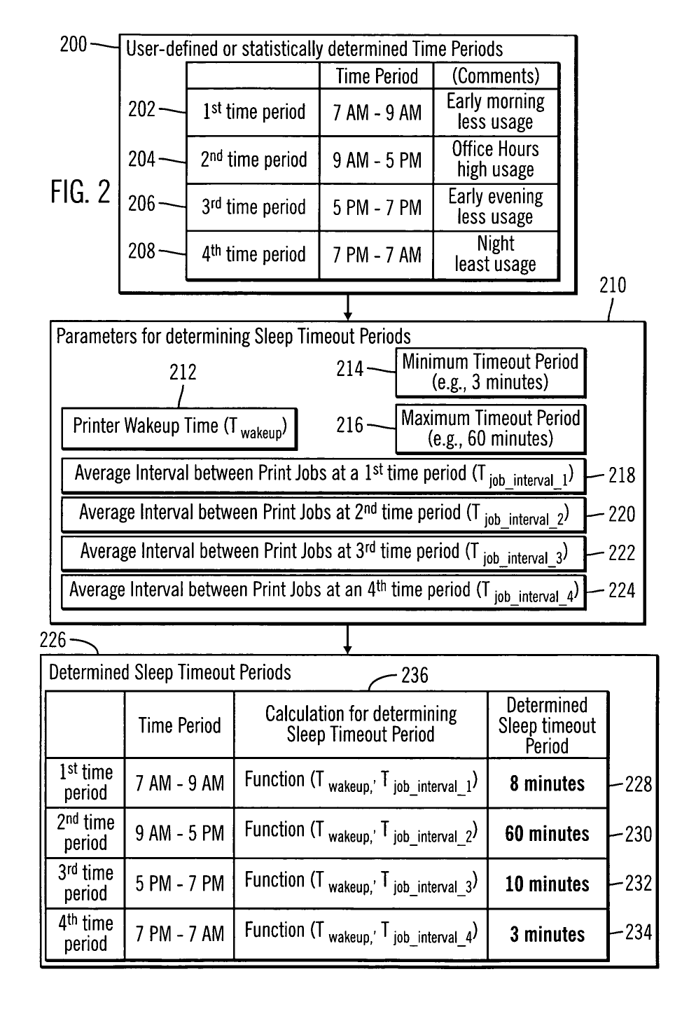

FIG. 2 illustrates a block diagram that shows data structures and operations for determining sleep timeout periods, in accordance with certain embodiments. The data structures and operations illustrated in FIG. 2 may be implemented in the computing environment 100 of FIG. 1.

A user-defined or statistically determined set of time periods 200 may be implemented by the timeout adjustment application 108. For example, an exemplary set of time periods 200 may include four different time periods for a day, a 1^{st} time period 202 between 7 AM and 9 AM when it is early morning and there is less usage of the printer 102, a 2^{nd} time period 204 between 9 AM and 5 PM which corresponds to the hours an office is open and there is high usage for the printer 102, a 3^{rd} time period 206 between 5 PM and 7 PM corresponding to early evening when there is less usage of the printer 102, and a 4^{th} time period 208 between 7 PM and 7 AM when there is least usage of the printer 102. The exemplary time periods 202, 204, 206, 208 may be set by a user via the operator panel 112 or via the remote printer control application 116. The timeout adjustment application 108 may collect statistics of printer usage during the exemplary time periods 202, 204, 206, 208 over a period of days and subsequently adjust the sleep timeout period by analyzing the collected statistics of printer usage.

Exemplary parameters 210 for determining sleep timeout periods may include a printer wakeup time 212 represented by T_{wakeup}, a minimum timeout period 214, a maximum timeout period 216, an average interval 218 between print jobs at the 1^{st} time period 202 (represented by T_{job}_{_{—}}ᵢₙₜₑᵣᵥₐₗ_{_{—}}₁), an average interval 220 between print jobs at the 2^{nd} time period 204 (represented by T_{job}_{_{—}}ᵢₙₜₑᵣᵥₐₗ_{_{—}}₂), an average interval 222 between print jobs at the 3^{rd} time period 206 (represented by T_{job}_{_{—interval}}_{_{—}}₃), and an average interval 224 between print jobs at the 4^{th} time period 208 (represented by T_{job}_{_{—}}ᵢₙₜₑᵣᵥₐₗ_{_{—}}₄). The average intervals 218, 220, 222, 224 between print jobs may be computed by the timeout application 108 from printer usage statistics stored in the database 110.

The printer wakeup 212 is the time the printer 102 needs to restart printing when the printer 102 is woken up from a sleep mode. For example, an exemplary printer may take 30 seconds to wakeup from a sleep mode.

The minimum timeout period 214 of a printer may correspond to the minimum value of the sleep timeout period that can be set for the printer. For example, an exemplary minimum timeout period 214 may be three minutes for the printer 102. The maximum timeout period 216 for a printer may correspond to the maximum value of the sleep timeout period that can be set for the printer. For example, an exemplary maximum timeout period 216 may be 60 minutes for the printer 102.

In certain embodiments, the determined sleep timeout periods 226 at the various time periods 202, 204, 206, 208 may be computed by the timeout adjustment application 108. For example, in certain embodiments, the determined sleep timeout period at the 1^{st} time period 202 may be determined to be 8 minutes (reference numeral 228), the determined sleep timeout period at the 2^{nd} time period 204 may be determined to be 60 minutes (reference numeral 230), the determined sleep timeout period at the 3^{rd} time period 206 may be determined to be 10 minutes (reference numeral 232), and the determined sleep timeout period at the 4^{th} time period 208 may be determined to be 3 minutes (reference numeral 234). In certain exemplary embodiments, the determined sleep timeout periods 228, 230, 232, 234 lie between the minimum time period 214 and the maximum time period 216, and are calculated (reference numeral 236) based on of the printer wakeup time 212 and the average interval between print jobs 218, 220, 222, 224.

In FIG. 2, the exemplary sleep timeout period 230 during office hours between 9 AM to 5 PM may be set to the maximum timeout period 216 of sixty minutes because the average time interval between print jobs 220 is relatively small, whereas the exemplary sleep timeout period 234 during 7 PM and 7 AM may be set to the minimum timeout period 214 of 3 minutes because the average time interval between print jobs 224 is relatively large. Additionally, the sleep timeout period 228 is set to 8 minutes during the 1^{st} time period 202 between 7 AM to 9 AM, and the sleep timeout period 232 is set to 10 minutes during the 3^{rd} time period between 5 PM to 7 PM.

Therefore, FIG. 2 illustrates certain embodiments in which different sleep timeout periods 228, 230, 232, 234 are set for different times of the day based on the average time interval between jobs.

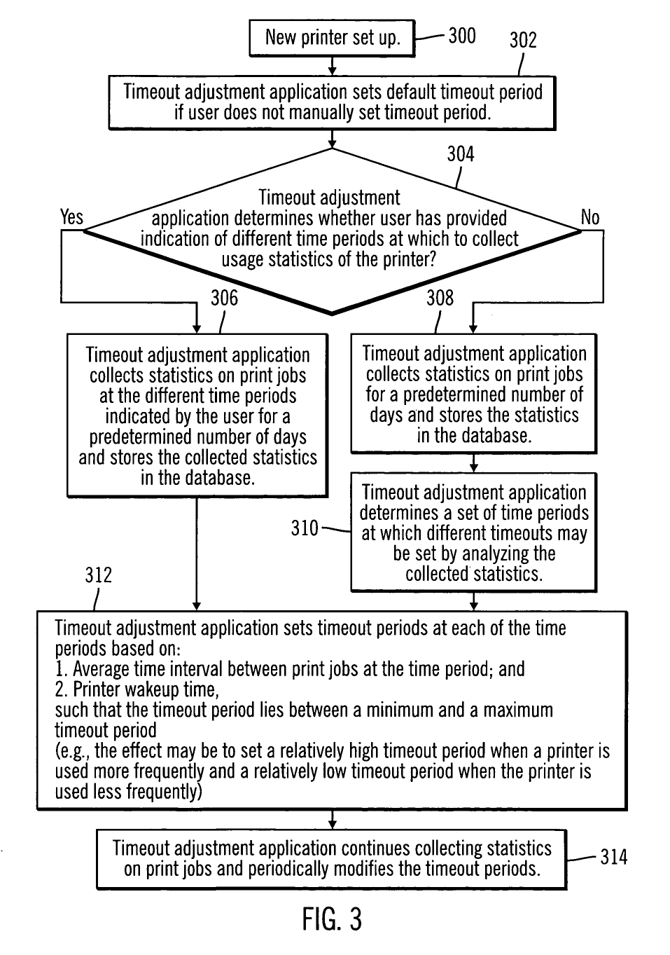

FIG. 3 illustrates a flowchart for modifying and adjusting timeout periods, in accordance with certain embodiments. Certain of the operations illustrated in FIG. 3 may be implemented by the timeout adjustment application 108 implemented in either the printer 102 or the computational device 104.

Control starts at block 300, where a new printer may be set up. The timeout adjustment application 108 sets (at block 302) a default sleep timeout period if a user does not manually set a sleep timeout period.

Subsequently, the timeout adjustment application 108 determines (at block 304) whether the user has provided an indication of different time periods 202, 204, 206, 208 at which to collect usage statistics of the printer 102. If so, the timeout adjustment application 108 collects (at block 306) statistics on print jobs at the different time periods 202, 204, 206, 208 indicated by the user for a predetermined number of days and stores the collected statistics in the database 110.

If the timeout adjustment application 108 determines that the user has not provided an indication of different time periods 202, 204, 206, 208 at which to collect usage statistics of the printer 102, then the timeout adjustment application 108 collects (at block 308) statistics on print jobs for a predetermined number of days and stores the statistics in the database 110. Subsequently, at block 310, the timeout adjustment application 108 determines a set of time periods at which different sleep timeout periods may be set by analyzing the collected statistics.

From blocks 306 and 310 control proceeds to block 312, where the timeout adjustment application 108 sets sleep timeout periods at each of the time periods 218, 220, 222, 224 based on:
1. Average time interval between print jobs at the time period; and
2. Printer wakeup time 212, such that the sleep timeout period lies between a minimum 214 and a maximum 216 timeout period. The net effect may be to set a relatively high timeout period when a printer is used more frequently and a relatively low timeout period when the printer is used less frequently.

While FIG. 3 has illustrated the computation of sleep timeout periods based on the average time interval between print jobs, in alternative embodiments other measures that compute the relative frequency of usage of a printer may be used to compute the sleep timeout periods.

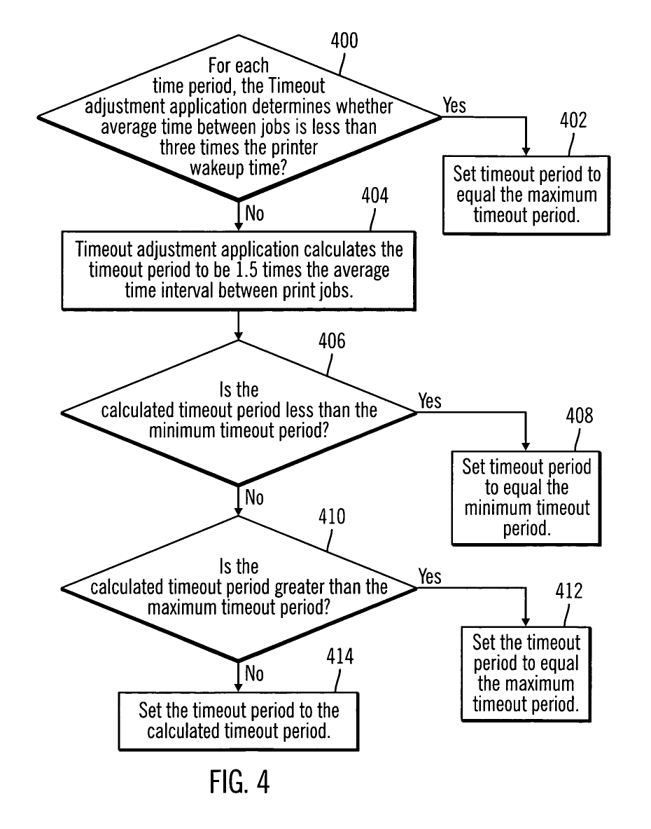

FIG. 4 illustrates a flowchart for setting timeout periods, in accordance with certain embodiments. Certain of the operations illustrated in FIG. 4 may be implemented by the timeout adjustment application 108 implemented in either the printer 102 or the computational device 104.

Control starts at block 400, where for each time period, the timeout adjustment application 108 determines whether the average time between jobs is less than a predetermined multiple, e.g., three times, of the printer wakeup time 212. If so, then the timeout adjustment application 108 sets (at block 402) the sleep timeout period to equal the maximum timeout period 216. If not, then the timeout adjustment application 108 calculates (at block 404) the sleep timeout period to be a predetermined multiple, e.g., 1.5 times, of the average time interval between print jobs.

The timeout adjustment application 108 determines (at block 406) whether the calculated timeout period is less than the minimum timeout period 214. If so, then the timeout adjustment application 108 sets (at block 408) the sleep timeout period to equal the minimum timeout period 214. If not, the timeout adjustment application 108 determines (at block 410) whether the calculated timeout period is greater than the maximum timeout period 216. If so, then the timeout adjustment application 108 sets (at block 412) the sleep timeout period to equal the maximum timeout period 216.

If at block 410, the timeout adjustment application 108 determines that the calculated timeout period is not greater then the maximum timeout period 216, then the calculated timeout period lies between the minimum timeout period 214 and the maximum timeout period 216, and the timeout adjustment application 108 sets (at block 414) the sleep timeout period to equal the calculated timeout period.

Therefore, FIG. 4 illustrates certain embodiments, in which the sleep timeout periods at different times of the day may be set to different values. A relatively high sleep timeout period may be set when a printer is used more frequently and a relatively low sleep timeout period when the printer is used less frequently.

### ADDITIONAL EMBODIMENT DETAILS

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

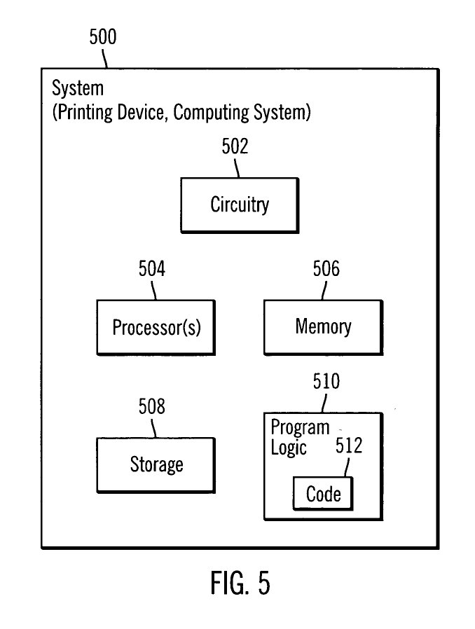

FIG. 5 illustrates an exemplary system 500, wherein in certain embodiments the printer 102 and the computational device 104 of the computing environment 100 of FIG. 1 may be implemented in accordance with the computer architecture of the computer system 500. The system 500 may also be referred to as a computer system, and may include a circuitry 502 that may in certain embodiments include a processor 504. The system 500 may also include a memory 506 (e.g., a volatile memory device), and storage 508. Certain elements of the system 500 may or may not be found in the printer 102 and the computational device 104 of FIG. 1. The storage 508 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 508 may comprise an internal storage device, an attached storage device and/or a network accessible storage device. The system 500 may include a program logic 510 including code 512 that may be loaded into the memory 506 and executed by the processor 504 or circuitry 502. In certain embodiments, the program logic 510 including code 512 may be stored in the storage 508. In certain other embodiments, the program logic 510 may be implemented in the circuitry 502. Therefore, while FIG. 5 shows the program logic 510 separately from the other elements, the program logic 510 may be implemented in the memory 506 and/or the circuitry 502.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in FIGS. 3 and 4 may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-5 are described as having specific types of information. In alternative embodiments, the data structures and components may be structured differently and have fewer, more or different fields or different functions than those shown or referred to in the figures. Therefore, the foregoing description of the embodiments has been presented for the purposes of illustration and description. It is not intended to be exhaustive or to limit the embodiments to the precise form disclosed. Many modifications and variations are possible in light of the above teaching.

What is claimed is:

1. A method, comprising:
determining printer usage corresponding to a plurality of time periods of a day for a plurality of days; and
setting sleep timeout periods corresponding to the plurality of time periods of the day based on the determined printer usage.

2. The method of claim 1, wherein a first sleep timeout period is set for a first time period of the day, wherein a second sleep timeout period is set for a second time period of the day, and wherein the first sleep timeout period is more than the second sleep timeout period if the printer usage during the first time period of the day is more than the printer usage during the second time period of the day.

3. The method of claim 1, further comprising:
determining for a time period whether an average time interval between print jobs is less than a predetermined multiple of a printer wakeup time; and
setting a sleep timeout period corresponding to the time period to equal a maximum timeout period, in response to determining the average time interval between the print jobs is less than the predetermined multiple of a printer wakeup time;

4. The method of claim 3, further comprising:
computing the sleep timeout period corresponding to the time period to be a predetermined multiple of the average time interval between print jobs, in response to determining that the average time interval between the print jobs is not less than the predetermined multiple of the printer wakeup time.

5. The method of claim 4, further comprising:
setting the sleep timeout period to equal the computed sleep timeout period if the computed sleep timeout period is greater than or equal to a minimum timeout period and the computed sleep timeout period is less than or equal to the maximum timeout period;
setting the sleep timeout period to equal the minimum timeout period, if the computed sleep timeout period is less than the minimum timeout period; and
setting the sleep timeout period to equal the maximum timeout period, if the computed sleep timeout period is greater than the maximum timeout period.

6. A system, comprising:
memory; and
processor coupled to the memory, wherein the processor executes:
determining printer usage corresponding to a plurality of time periods of a day for a plurality of days; and
setting sleep timeout periods corresponding to the plurality of time periods of the day based on the determined printer usage.

7. The system of claim 6, wherein a first sleep timeout period is set for a first time period of the day, wherein a second sleep timeout period is set for a second time period of the day, and wherein the first sleep timeout period is more than the second sleep timeout period if the printer usage during the first time period of the day is more than the printer usage during the second time period of the day.

8. The system of claim 6, wherein the processor further executes:
determining for a time period whether an average time interval between print jobs is less than a predetermined multiple of a printer wakeup time; and
setting a sleep timeout period corresponding to the time period to equal a maximum timeout period, in response to determining the average time interval between the print jobs is less than the predetermined multiple of a printer wakeup time;

9. The system of claim 8, wherein the processor further executes:
computing the sleep timeout period corresponding to the time period to be a predetermined multiple of the average time interval between print jobs, in response to determining that the average time interval between the print jobs is not less than the predetermined multiple of the printer wakeup time.

10. The system of claim 9, wherein the processor further executes:
setting the sleep timeout period to equal the computed sleep timeout period if the computed sleep timeout period is greater than or equal to a minimum timeout period and the computed sleep timeout period is less than or equal to the maximum timeout period; a
setting the sleep timeout period to equal the minimum timeout period, if the computed sleep timeout period is less than the minimum timeout period; and
setting the sleep timeout period to equal the maximum timeout period, if the computed sleep timeout period is greater than the maximum timeout period.

11. An article of manufacture for controlling a printer, wherein the article of manufacture is capable of causing operations, the operations comprising:
determining printer usage corresponding to a plurality of time periods of a day for a plurality of days; and
setting sleep timeout periods corresponding to the plurality of time periods of the day based on the determined printer usage.

12. The article of manufacture of claim 11, wherein a first sleep timeout period is set for a first time period of the day, wherein a second sleep timeout period is set for a second time period of the day, and wherein the first sleep timeout period is more than the second sleep timeout period if the printer usage during the first time period of the day is more than the printer usage during the second time period of the day.

13. The article of manufacture of claim 11, the operations further comprising:
determining for a time period whether an average time interval between print jobs is less than a predetermined multiple of a printer wakeup time; and
setting a sleep timeout period corresponding to the time period to equal a maximum timeout period, in response to determining the average time interval between the print jobs is less than the predetermined multiple of a printer wakeup time;

14. The article of manufacture of claim 13, the operations further comprising:
computing the sleep timeout period corresponding to the time period to be a predetermined multiple of the average time interval between print jobs, in response to determining that the average time interval between the print jobs is not less than the predetermined multiple of the printer wakeup time.

15. The article of manufacture of claim 14, the operations further comprising:
setting the sleep timeout period to equal the computed sleep timeout period if the computed sleep timeout period is greater than or equal to a minimum timeout period and the computed sleep timeout period is less than or equal to the maximum timeout period;
setting the sleep timeout period to equal the minimum timeout period, if the computed sleep timeout period is less than the minimum timeout period; and
setting the sleep timeout period to equal the maximum timeout period, if the computed sleep timeout period is greater than the maximum timeout period.

16. A method for deploying computing infrastructure, comprising integrating computer-readable code into a computing system, wherein the code in combination with the computing system is capable of performing:
determining printer usage corresponding to a plurality of time periods of a day for a plurality of days; and
setting sleep timeout periods corresponding to the plurality of time periods of the day based on the determined printer usage.

17. The method for deploying computing infrastructure of claim 16, wherein a first sleep timeout period is set for a first time period of the day, wherein a second sleep timeout period is set for a second time period of the day, and wherein the first sleep timeout period is more than the second sleep timeout period if the printer usage during the first time period of the day is more than the printer usage during the second time period of the day.

18. The method for deploying computing infrastructure of claim 16, further comprising:
determining for a time period whether an average time interval between print jobs is less than a predetermined multiple of a printer wakeup time; and
setting a sleep timeout period corresponding to the time period to equal a maximum timeout period, in response to determining the average time interval between the print jobs is less than the predetermined multiple of a printer wakeup time;

19. The method for deploying computing infrastructure of claim 18, further comprising:
computing the sleep timeout period corresponding to the time period to be a predetermined multiple of the average time interval between print jobs, in response to determining that the average time interval between the print jobs is not less than the predetermined multiple of the printer wakeup time.

20. The method for deploying computing infrastructure of claim 19, further comprising:
setting the sleep timeout period to equal the computed sleep timeout period if the computed sleep timeout period is greater than or equal to a minimum timeout period and the computed sleep timeout period is less than or equal to the maximum timeout period;
setting the sleep timeout period to equal the minimum timeout period, if the computed sleep timeout period is less than the minimum timeout period; and
setting the sleep timeout period to equal the maximum timeout period, if the computed sleep timeout period is greater than the maximum timeout period.
